(19) United States
(12) Patent Application Publication
(10) Pub. No.: US 2024/0248885 A1
(43) Pub. Date: Jul. 25, 2024

(54) GENERATING SCHEMA

(71) Applicant: International Business Machines Corporation, Armonk, NY (US)

(72) Inventors: Matthew James Clarke, Newbury (GB); Vlad Balanescu, Southampton (GB); Matthew Paul Chapman, Eastleigh (GB); THOMAS LI, Winchester (GB)

(21) Appl. No.: 18/156,498

(22) Filed: Jan. 19, 2023

(51) Int. Cl. G06F 16/21; G06F 16/25

(52) U.S. Cl. CPC G06F 16/213; G06F 16/252

(57) ABSTRACT

Embodiments of the present invention provide concepts for a method for generating a schema describing a first node for performing mapping tasks. The method comprises obtaining an output schema for the first node. The method further comprises extracting, from the output schema, configuration data for the first node, wherein the configuration data includes an object and an action associated with the first node. The method further comprises analyzing a dataset of historical mappings to identify previous mappings that reference the object, or the action associated with the first node. The method further comprises generating a modified output schema describing the first node based, at least in part, on the identified previous mappings and the output schema, wherein the modified output schema is devoid of at least one portion of output schema.

### BACKGROUND

The technical character of the present invention generally relates to the field of data management, and more particularly, to generating schema for performing mapping tasks.

In an integration system, there are source and target nodes which contribute to mappings for an object (which can usually be referred to as “mappings from” and “mappings to” respectively). Typically, an object is described by a schema that details the properties and metadata of that object. This schema can be used to represent the source and target node in the context of performing a mapping task.

A schema can be very large in size, due to the number of hierarchical levels (i.e., nesting levels), the overall quantity of fields, and the amount of associated metadata with each single field.

An integration system performing a mapping task on large objects would typically need the complete schemas for all possible sources and target objects. This can negatively impact the ability to perform a mapping task for the following reasons:

Acquisition of large schemas may take long processing times to generate the valid schema used by the system. A large schema would mean a large response being returned to a client requesting the schema from the server. This data would be transferred over a HTTPS protocol and the larger the response, the longer it would take to return it to the client.

When there is a User Interface (UI) component to aid with mapping, a large schema may require some pre-processing before rendering in the UI. The larger the schema, the longer this pre-processing may take. Furthermore, a schema with many levels of hierarchy and/or many properties to be used in a mapping task may be difficult to present in a consumable user experience via the UI. This would reduce the ease and speed at which a common mapping task might be performed (in terms of finding the correct property to map to, and the correct property to map from). Thus, a very large schema can negatively impact the ability to perform a mapping task efficiently and accurately.

### SUMMARY

The present invention seeks to provide a method for generating a schema describing a first node for performing mapping tasks. The method comprises obtaining an output schema for the first node. The method further comprises extracting, from the output schema, configuration data for the first node, wherein the configuration data includes an object and an action associated with the first node. The method further comprises analyzing a dataset of historical mappings to identify previous mappings that reference the object, or the action associated with the first node. The method further comprises generating a modified output schema describing the first node based, at least in part, on the identified previous mappings and the output schema, wherein the modified output schema is devoid of at least one portion of output schema.

According to an embodiment of the present invention there is provided a computer-implemented method for generating a schema describing a first node for performing mapping tasks. The method comprises: obtaining an output schema for the first node; extracting, from the output schema, configuration data for the first node, wherein the configuration data includes an object and an action associated with the first node; analyzing a dataset of historical mappings to identify previous mappings that reference the object or the action associated with the first node; and based on the identified previous mappings and the output schema, generating a modified output schema describing the first node. The modified output schema is devoid of at least one portion of output schema.

According to another embodiment of the present invention a computer program product for generating a schema describing a first node for performing mapping tasks is disclosed. The computer program product comprising a computer readable storage medium having program instructions embodied therewith, the program instructions executable by a processing unit to cause the processing unit to perform a method. The method comprises obtaining an output schema for the first node. The method further comprises extracting, from the output schema, configuration data for the first node, wherein the configuration data includes an object and an action associated with the first node. The method further comprises analyzing a dataset of historical mappings to identify previous mappings that reference the object, or the action associated with the first node. The method further comprises generating a modified output schema describing the first node based, at least in part, on the identified previous mappings and the output schema, wherein the modified output schema is devoid of at least one portion of output schema.

According to another embodiment of the present invention, a computer system for generating a schema describing a first node for performing mapping tasks is disclosed is disclosed. The computer system includes one or more computer processors, one or more computer readable storage media, and computer program instructions, the computer program instructions being stored on the one or more computer readable storage media for execution by the one or more computer processors. The program instructions include instructions to obtain an output schema for the first node. The program instructions further include instructions to extract, from the output schema, configuration data for the first node, wherein the configuration data includes an object and an action associated with the first node. The program instructions include instructions to analyze a dataset of historical mappings to identify previous mappings that reference the object, or the action associated with the first node. The program instructions include instructions to generate a modified output schema describing the first node based, at least in part, on the identified previous mappings and the output schema, wherein the modified output schema is devoid of at least one portion of output schema.

Thus, there may be provided a concept of generating an optimized schema that is generated and provided as part of a mapping task. When performing a mapping task from a source object to a target object, the schemas generated according to the proposed concept(s) may only contain the properties and metadata that are most used. In particular, embodiments propose to use the input(s) from previously performed mapping tasks in the system to determine what parts of a schema are most frequently/commonly used.

Put another way, the invention seeks to provide a more efficient (e.g., smaller) schema by leveraging a dataset of historical mappings to identify previously used mappings. Based on the identified previous mappings, a modified output schema may be generated which is smaller in size. That is, the modified output schema may only comprise commonly/frequently used mappings, and thus be devoid of at least one portion of previous (i.e., unmodified) output schema.

It is proposed that an optimal subset of source and target schemas may be generated (when used in the context of a mapping task) by analyzing previous mappings to identify the ‘most-used’ mappings.

Embodiments may provide schema that is smaller in size. By reducing the size of the schema for the mapping system, embodiments may provide the following benefits:
reduce the time taken to initially generate the schema by only needing to generate the most common parts;
reduce the size of the schema that needs to be sent by a server responding to a request, thus reducing the time taken to transfer that schema over a HTTPS request;
reduce the levels of hierarchy and/or the number of properties that can be used in the mapping task, which may improve the rendering of the user experience and ability to work with the schemas in the mapping task.

Accordingly, embodiments may facilitate improved speed and system performance in generating mapping schemas. This may reduce a time in making them available for performing the mapping task. Also, the reduced size of the schema may improve the ability to work with those large objects (e.g. better user experience, reduced cognitive load, quicker time to value performing the mapping task, etc.).

In some embodiments, modifying the output schema comprises: based on the identified previous mappings; determining a set of mappings that meet a predetermined usage requirement; identifying one or more portions of the output schema that do not refer to at least one mapping of the set of mappings; and editing or removing the identified one or more portions of the output schema.

By way of example, determining a set of mappings that meet a predetermined usage requirement may comprise: for each of the identified previous mappings: determining a frequency of occurrence of the identified previous mapping in the dataset of historical mappings; and if the determined frequency of occurrence of the identified previous mapping exceeds a predetermined usage value, including the identified previous mapping in the set of mappings.

In an embodiment, analyzing a dataset of historical mappings may comprise: for each mapping between the object and action associated with the first node: comparing the mapping with the dataset of historical mappings to determine whether or not to identify the mapping as a previous mapping; and responsive to identifying the mapping as a previous mapping, increasing a usage score value associated with the previous mapping, wherein a usage score value represents a frequency of occurrence of the associated mapping in the dataset of historical mappings.

In an embodiment, the method may further comprise: generating supplementary information describing the at least one portion of output schema that devoid from modified output schema; and associating the supplementary information with the modified output schema.

For instance, associating the supplementary information with the modified output schema may comprise: including the supplementary information in the modified output schema.

In an embodiment, the first node may be an input node of a flow, and the method may further comprise communicating the modified output schema to a client.

In some embodiments, the first node may be a downstream node of a flow. The method may then further comprise: obtaining an input schema for the first node; extracting, from the input schema, second configuration data for the first node, wherein the second configuration data includes a second object and a second action associated with the first node; analyzing the dataset of historical mappings to identify previous mappings that reference the second object or the second action associated with the first node; and based on the identified previous mappings, modifying the input schema to generate a modified input schema describing the first node, wherein the modified input schema is devoid of at least a portion of input schema.

By way of further example, modifying the input schema may comprise: based on the identified previous mapping that reference the second object or the second action associated with the first node, determining a second set of mappings that meet a predetermined usage requirement; identifying one or more portions of the input schema that do not refer to at least one mapping of the second set of mappings; and editing or removing the identified one or more portions of the input schema.

Further, determining a second set of mappings that meet a predetermined usage requirement may comprise: for each of the identified previous mappings that reference the second object or the second action associated with the first nodes: determining a frequency of occurrence of the identified previous mapping in the dataset of historical mappings; and if the determined frequency of occurrence of the identified previous mapping exceeds a predetermined usage value, including the identified previous mapping in the second set of mappings.

An embodiment may further comprise: generating second supplementary information describing the at least one portion of input schema that devoid from modified input schema; and associating the second supplementary information with the modified input schema.

For example, associating the second supplementary information with the modified input schema may comprise: including the second supplementary information in the modified input schema.

In addition, embodiments of the present invention provide concepts for a computer program product for generating a schema describing a first node for performing mapping tasks, the computer program product comprising a computer readable storage medium having program instructions embodied therewith, the program instructions executable by a processing unit to cause the processing unit to perform a method comprising: obtaining an output schema for the first node; extracting, from the output schema, configuration data for the first node, wherein the configuration data includes an object and an action associated with the first node; analyzing a dataset of historical mappings to identify previous mappings that reference the object or the action associated with the first node; and based on the identified previous mappings and the output schema, generating a modified output schema describing the first node, wherein the modified output schema is devoid of at least one portion of output schema.

In an embodiment, modifying the output schema may comprise: based on the identified previous mappings; determining a set of mappings that meet a predetermined usage requirement; identifying one or more portions of the output schema that do not refer to at least one mapping of the set of mappings; and editing or removing the identified one or more portions of the output schema.

Determining a set of mappings that meet a predetermined usage requirement comprises: for each of the identified previous mappings: determining a frequency of occurrence of the identified previous mapping in the dataset of historical mappings; and if the determined frequency of occurrence of the identified previous mapping exceeds a predetermined usage value, including the identified previous mapping in the set of mappings.

In an embodiment, analyzing a dataset of historical mappings may comprise: for each mapping between the object and action associated with the first node: comparing the mapping with the dataset of historical mappings to determine whether or not to identify the mapping as a previous mapping; responsive to identifying the mapping as a previous mapping, increasing a usage score value associated with the previous mapping, wherein a usage score value represents a frequency of occurrence of the associated mapping in the dataset of historical mappings.

In an embodiment, the method may further comprise: generating supplementary information describing the at least one portion of output schema that devoid from modified output schema; and associating the supplementary information with the modified output schema. Further, associating the supplementary information with the modified output schema may comprise: including the supplementary information in the modified output schema.

In an embodiment, the first node may be an input node of a flow, and the method may further comprise communicating the modified output schema to a client.

In another embodiment, the first node may be a downstream node of a flow, and the method may then further comprise: obtaining an input schema for the first node; extracting, from the input schema, second configuration data for the first node, wherein the second configuration data includes a second object and a second action associated with the first node; analyzing the dataset of historical mappings to identify previous mappings that reference the second object or the second action associated with the first node; and based on the identified previous mappings, modifying the input schema to generate a modified input schema describing the first node, wherein the modified input schema is devoid of at least a portion of input schema.

By way of example, modifying the input schema may comprise: based on the identified previous mapping that reference the second object or the second action associated with the first node, determining a second set of mappings that meet a predetermined usage requirement; identifying one or more portions of the input schema that do not refer to at least one mapping of the second set of mappings; and editing or removing the identified one or more portions of the input schema.

In an embodiment, determining a second set of mappings that meet a predetermined usage requirement may comprise: for each of the identified previous mappings that reference the second object or the second action associated with the first nodes: determining a frequency of occurrence of the identified previous mapping in the dataset of historical mappings; and if the determined frequency of occurrence of the identified previous mapping exceeds a predetermined usage value, including the identified previous mapping in the second set of mappings.

In addition, embodiments may further comprise generating second supplementary information describing the at least one portion of input schema that devoid from modified input schema; and associating the second supplementary information with the modified input schema.

In addition, embodiments of the present invention provide concepts for a processing system comprising at least one processor and the computer program product according to one or more embodiments, wherein the at least one processor is adapted to execute the computer program code of said computer program product.

Embodiments may be employed in combination with conventional/existing integration systems that work with very large schemas that map object properties in an integration flow. In this way, embodiments may integrate into legacy systems so as to improve and/or extend their functionality and capabilities. An improved integration system may therefore be provided by proposed embodiments.

According to another aspect, there is provided a system for generating a schema describing a first node for performing mapping tasks. The system comprises: a processor arrangement configured to perform the steps of: obtaining an output schema for the first node; extracting, from the output schema, configuration data for the first node, wherein the configuration data includes an object and an action associated with the first node; analyzing a dataset of historical mappings to identify previous mappings that reference the object or the action associated with the first node; and based on the identified previous mappings and the output schema, generating a modified output schema describing the first node. The modified output schema is devoid of at least one portion of output schema.

Thus, there may be proposed concepts for generating a schema describing a node for performing mapping tasks, wherein previously performed mapping tasks in the system are analyzed to determine what parts of a schema are most frequently/commonly used. Using a dataset of historical mappings to identify previously used mappings may help to reduce schema size by avoiding the inclusion of redundant, unneeded, superfluous (e.g., previously un-used) mappings.

### BRIEF DESCRIPTION OF THE DRAWINGS

FIG. 1 depicts an illustrative computing environment according to embodiments of the present invention.

FIG. 2 illustrates a method for generating a schema describing a first node for performing mapping tasks according to an aspect of the invention.

FIG. 3 depicts an exemplary implementation of the method of FIG. 2.

FIG. 4 illustrates an extension to the method of FIG. 2.

FIG. 5 depicts an exemplary implementation of the method of FIG. 4.

FIG. 6 illustrates an exemplary mapping scenario wherein the proposed concept(s) are not employed.

FIG. 7 illustrates a change to exemplary mapping scenario of FIG. 6 resulting from use of an embodiment of the invention.

### DETAILED DESCRIPTION

The technical character of the present invention generally relates to the field of data management, and more particularly, to generating schema for performing mapping tasks.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a portable computing device (such as a tablet computer, laptop, smartphone, etc.), a set-top box, a server or a collection of PCs and/or servers connected via a network such as a local area network, the Internet and so on to cooperatively execute at least one embodiment of the methods of the present invention.

The technical character of the present invention generally relates to integration systems employing source and target nodes which contribute to mappings for an object, and more particularly to schema generation concepts that may for example, provide schemas of smaller size. More specifically, embodiments of the present invention provide concepts for generating a schema describing a first node for performing mapping tasks, the method comprising: obtaining an output schema for the first node; extracting, from the output schema, configuration data for the first node, wherein the configuration data includes an object and an action associated with the first node; analyzing a dataset of historical mappings to identify previous mappings that reference the object or the action associated with the first node; and based on the identified previous mappings and the output schema, generating a modified output schema describing the first node. The modified output schema is devoid of at least one portion of output schema.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

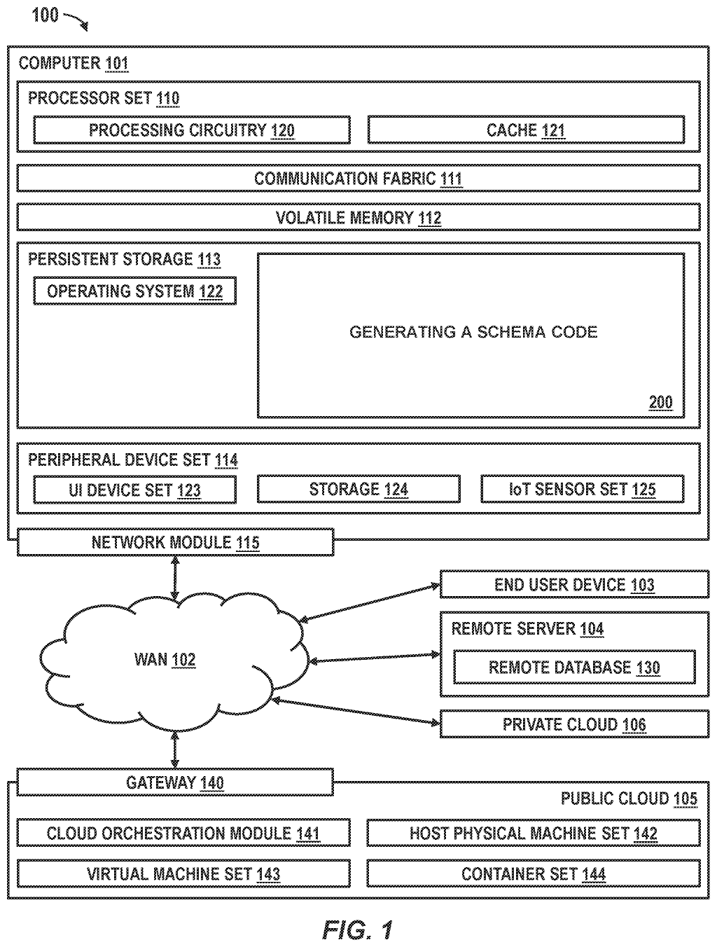

Referring now to FIG. 1, an illustrative computing environment 100 is depicted. A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a proposed method for generating a schema describing a node 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

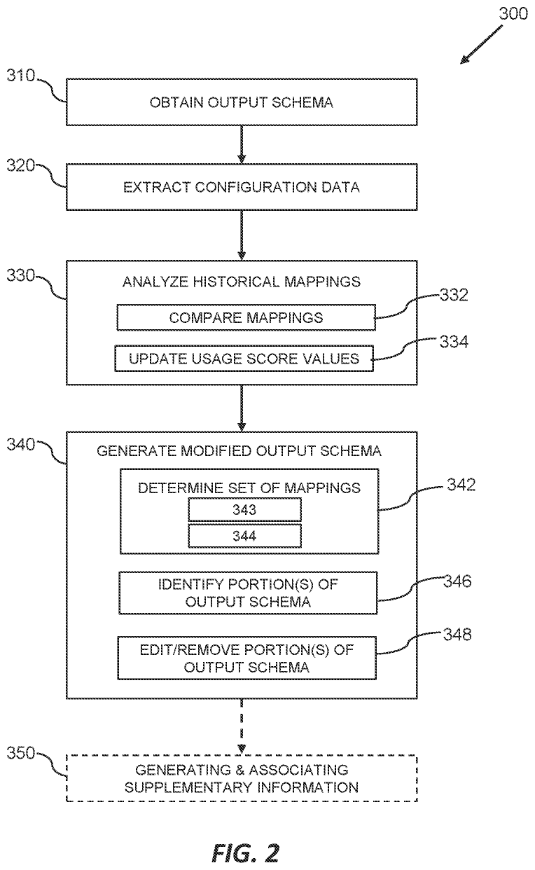

Referring now to FIG. 2, there is depicted a flow diagram of a computer-implemented method 300 according to an embodiment. The method is for generating a schema describing a first node for performing mapping tasks. In this example, the first node is an input node of a flow.

The method begins with the step 310 of obtaining an output schema for the first node. Next, in step 320, configuration data for the first node is extracted from the output schema. The extracted configuration data includes an object and an action associated with the first node.

The method then proceeds to step 330 which comprises analyzing a dataset of historical mappings to identify previous mappings that reference the object or the action associated with the first node. Here, the step 330 of analyzing the dataset of historical mappings comprises two undertaking two sub-steps 332 and 334 for each mapping between the object and action associated with the first node. Specifically, for each mapping between the object and action associated with the first node, analyzing the dataset of historical mappings comprises: (step 332) comparing the mapping with the dataset of historical mappings to determine whether or not to identify the mapping as a previous mapping; and (step 334) responsive to identifying the mapping as a previous mapping, increasing a usage score value associated with the previous mapping, wherein a usage score value represents a frequency of occurrence of the associated mapping in the dataset of historical mappings. For instance, the usage score value in this example comprises a count value for each mapping, and the usage score value of a mapping is incremented when the mapping is identified as previous mapping (i.e., determined to have been used previously). In an embodiment, the method ends if it is determined the mapping is not a previous mapping.

Next, in step 340, a modified output schema describing the first node is generated based on the identified previous mappings and the output schema. Here, modifying the output schema comprises sub-steps 342-348:

At step 342, based on the identified previous mappings, a set of mappings that meet a predetermined usage requirement are determined. For instance, this is achieved by undertaking the following two steps for each of the identified previous mappings: (step 343) determining a frequency of occurrence of the identified previous mapping in the dataset of historical mappings; and (step 344) if the determined frequency of occurrence of the identified previous mapping exceeds a predetermined usage value, including the identified previous mapping in the set of mappings.

At step 346, one or more portions of the output schema that do not refer to at least one mapping of the set of mappings are identified.

At step 348, the identified one or more portions of the output schema are edited or removed.

In this way, the modified output schema is devoid of at least one portion of the output schema. That is, the one or more portions of the output schema that do not refer to at least one mapping of the set of mappings are removed from (or otherwise edited out of) the output schema, because their lack of previous usage indicates that have little to no value being included in the output schema for the first node.

The modified output schema may then be communicated to a client (e.g., via a conventional communication protocol and/or a display).

As indicated by the dashed box in FIG. 2, the method may also include the step 350 of: generating supplementary information describing the at least one portion of output schema that devoid from modified output schema; and associating the supplementary information with the modified output schema. For example, associating the supplementary information with the modified output schema may comprises including the supplementary information in the modified output schema. In this way, supplementary information describing the modifications made to the output schema may be provided in or with the schema.

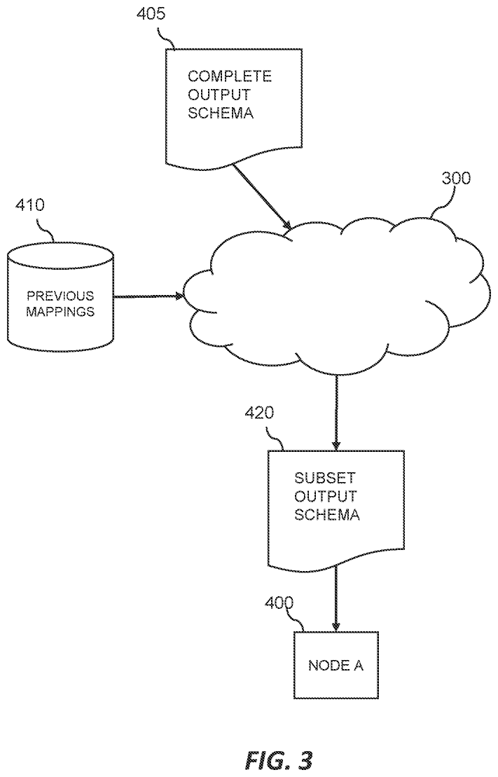

Referring now to FIG. 3, there is depicted an exemplary implementation of the method 300 described above with reference to FIG. 2. Specifically, the illustration of FIG. 3 shows the method 300 leveraging a dataset 410 of historical mappings to generate a subset output schema 420 for the first node 400 (‘Node A’).

By way of summary, the method 300 requests a complete output schema 405 for the first node 400 and extracting configuration data for the first node 400. The extracted configuration data includes an object associated with the node and an action associated with the first node 400. Mappings between the object and the action are then analyzed and compared with the dataset 410 of historical mappings (i.e., information describing previously used mappings). Weighting values of the mappings are updated based on the comparison results, so that the weighting value of a mapping relates to a frequency of the mapping in the dataset of historical mappings. The weighting values data from the dataset of historical mappings is then added to the complete output schema 405 and the complete output scheme 405 is filtered based on the weightings of the mappings so as to generate a modified output schema (i.e., subset output schema) 420 for the first node 400. For instance, mappings of the complete output scheme 405 having a weighting value below a determined threshold value are removed/deleted from the complete output scheme 405 to create a modified output schema 420.

By way of further explanation, the above examples of FIGS. 2-3 relate to a (first) scenario where an integration flow consists of just a target/starting node (i.e. first node) that requires an output schema. A method for generating the output schema according to a proposed embodiment may be summarized as follows:
(I) User adds the first node (NodeA) to the flow triggering the user interface to request the output (source) schema for that node.
(II) The system generates the optimal output subschema for NodeA:
   (a) Extracts the node configuration information for NodeA—the object Object1 (e.g. Sterling Order) and action Action1 (e.g. New Order);
   (b) Analyses the previous mappings dataset that reference that action Action1 and object Object1:
      (i) For all mappings that system has knowledge of:
      (ii) Identify all mappings that exist using Action1 and Object1 as a reference for a mapping;
      (iii) If it does add mapping to a mapping list with an initial weighting-score value of 1;
      (iv) For any mapping that already exists in the mapping list, increment the existing entry weighting-score by a value of 1;
      (v) Retain all mappings in the mapping list as mappingListOutput
   (c) Build the optimal output subschema schemaOutput
      (i) Starting from the complete output (source) schema schemaOutput for action Action1 and object Object1;
      (ii) Score the found mappings in mappingListOutput against the schema schemaOutput. When a mapping references a single part of schemaOutput schema, add the accumulated weighting-score of the mapping to that part of the schema. Repeat for all mappings in mappingListOutput.
      (iii) Build the optimal output subschema schemaOutputOptimal. Filter out sections from schemaOutput that do not meet a predetermined score threshold (starting at the leaf properties and recursively working back to the object root), until all high scoring parts of the schema only remain to form the sub schema schemaOutputOptimal.
   (d) Any areas of schema of schemaOutputOptimal that are hidden (i.e. not included) are annotated to denote that there is more schema available-this allows for requesting more schema from the UI.
(III) The generated schemaOutputOptimal is returned to the user interface for the mapping task.

Although the above described examples relate to a (first) scenario relating to a target/starting node (i.e., first node) that requires an output schema, proposed embodiments may also be applicable to a (second) scenario of a downstream node that requires both an input schema and an output schema.

When the node is a downstream node of a flow, the proposed method may be modified to include additional steps for generating an input schema. That is, the method of FIG. 2 may be employed for generating an output schema for the node, and then additional method steps based on the proposed concept(s) may be employed to generate an input schema for the node.

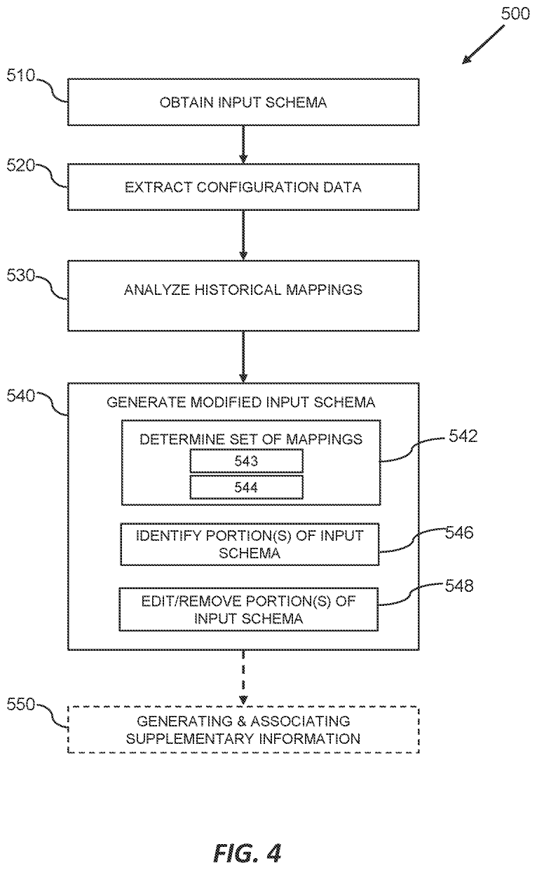

By way of example, FIG. 4 is a flow diagram of an extension 500 to the method of FIG. 2, wherein the steps illustrated in the flow diagram of FIG. 4 are adapted to generate (when executed) an input schema for the node.

The (extension) 500 to the method begins with step 510 of obtaining an input schema for the first node. Next, in step 520, second configuration data for the first node is extracted from the input schema. The second configuration data includes a second object and a second action associated with the first node.

The method then proceeds to step 530 which comprises analyzing the dataset of historical mappings to identify previous mappings that reference the second object or the second action associated with the first node.

Next, in step 540, a modified input schema describing the first node is generated based on the identified previous mappings and the input schema. In these embodiments, modifying the input schema comprises subs-steps 542-548:

Step 542—based on the identified previous mapping that reference the second object or the second action associated with the first node, determining a second set of mappings that meet a predetermined usage requirement. For instance, this is achieved by undertaking the following two steps for each of the identified previous mappings that reference the second object or the second action associated with the first nodes: (step 543) determining a frequency of occurrence of the identified previous mapping in the dataset of historical mappings; (step 544) if the determined frequency of occurrence of the identified previous mapping exceeds a predetermined usage value, including the identified previous mapping in the second set of mappings. If the determined frequency of occurrence of the identified previous mapping is below a predetermined usage value, the identified previous mapping is not included in the second set of mappings.

At step 546, one or more portions of the input schema that do not refer to at least one mapping of the second set of mappings are identified. At step 548, the identified one or more portions of the input schema are edited or removed.

In this way, the modified input schema is devoid of at least one portion of the input schema. That is, the one or more portions of the input schema that do not refer to at least one mapping of the set of mappings are removed from (or otherwise edited out of) the input schema, because their lack of previous usage indicates that have little to no value being included in the input schema for the first node.

The modified input schema may then be communicated to a client (e.g., via a conventional communication protocol and/or a display).

As indicated by the dashed box in FIG. 4, the (extension) method may also include the step 550 of: generating second supplementary information describing the at least one portion of input schema that devoid from modified input schema; and associating the second supplementary information with the modified input schema. For example, associating the second supplementary information with the modified input schema comprises including the second supplementary information in the modified input schema. In this way, supplementary information describing the modifications made to the input scheme may be provided in or with the schema.

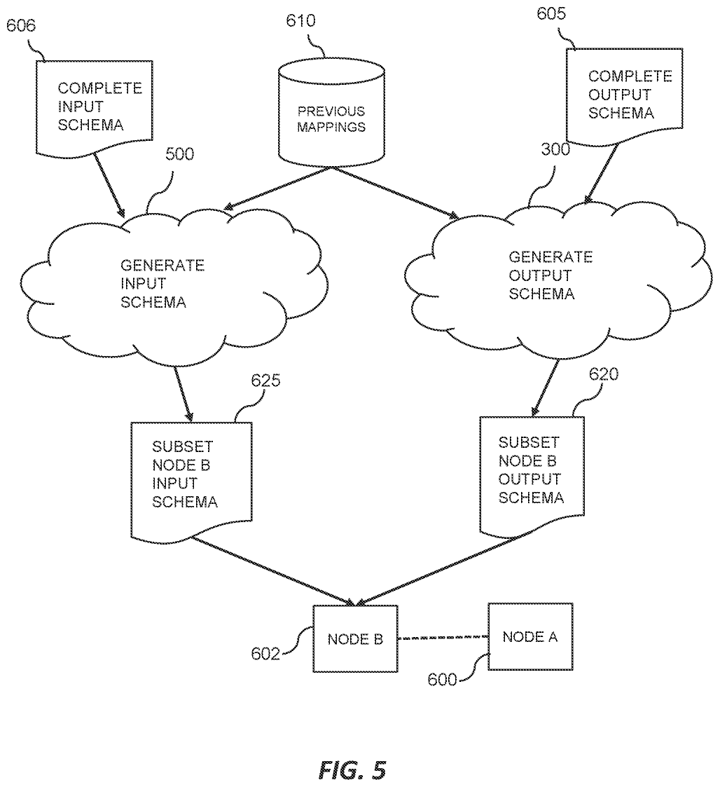

Referring now to FIG. 5, there is depicted an exemplary implementation of the method 500 described above with reference to FIG. 4. Specifically, the illustration of FIG. 5 shows the methods 300 and 500 leveraging a dataset 610 of historical mappings to generate a subset output schema 620 and a subset input schema 625 for the second node 602 (‘Node B’).

By way of summary, the method 300 requests a complete output schema 605 and input schema 606 for the second node 602 and extracts configuration data for the node 600. The extracted configuration data includes an object associated with the node and an action associated with the node 600. Mappings between the object and the action are then analyzed and compared with the dataset 610 of historical mappings (i.e., information describing previously used mappings). Weighting values of the mappings are updated based on the comparison results, so that the weighting value of a mapping relates to a frequency of the mapping in the dataset of historical mappings. The weighting values data from the dataset of historical mappings is then added to the complete input 606 and output 605 schemas, and the complete schemas are then filtered based on the weightings of the mapping to generate a modified input schema (i.e., subset input schema) 625 and a modified output schema (i.e., subset output schema) 620 for the node 602. For instance, mappings of the complete output scheme 605 having a weighting value below a determined threshold value are removed/deleted from the complete output scheme 605 to create a modified output schema 620. Similarly, mappings of the complete input scheme 606 having a weighting value below a determined threshold value are removed/deleted from the complete input schema 606 to create a modified input schema 625.

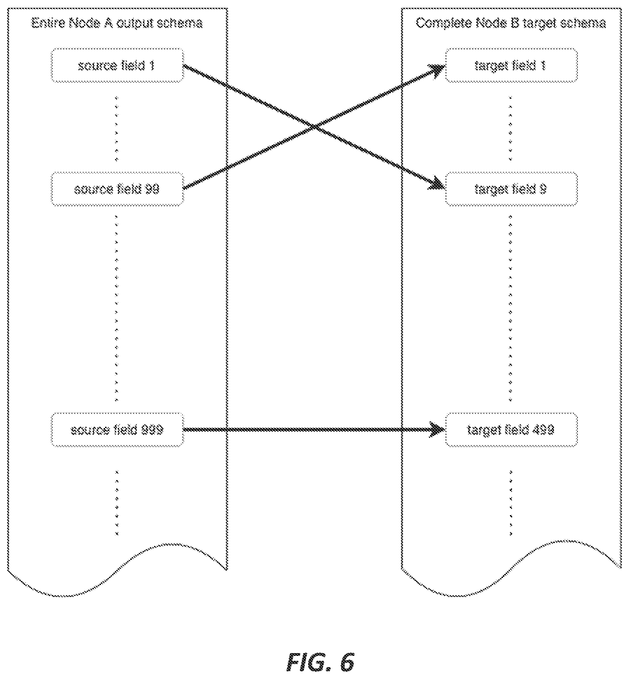

By way of demonstrating a result of the proposed concept(s), reference is now made to FIGS. 6 & 7.

FIG. 6 illustrates an exemplary mapping scenario wherein the proposed concept(s) are not employed. That is, an entire Node A output schema is depicted along with a complete Node B target schema. Although not all of the information of each schema is shown, mappings between source and target fields are depicted by arrows.

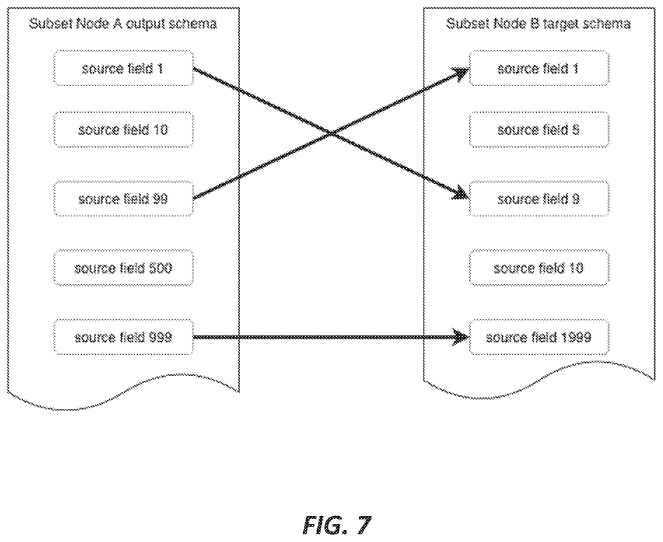

FIG. 7 on the other hand illustrates a change to the schema of FIG. 6 resulting from use of an embodiment of the invention. More specifically, a subset Node A output schema is depicted along with a subset Node B target schema. The subset schemas each comprise information about only a subset of the source fields, although the mappings from Node A to Node B are maintained.

Thus, it can be seen how the proposed concept(s) provided schema of a smaller/reduced size whilst maintaining mapping information.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may in fact, be executed substantially concurrently, or the blocks may sometimes be executed in the reverse order, depending upon the functionality involved.

In contrast to existing schema generation approaches, the methods and systems of the invention provide schema of reduced size that maintain required mapping information.

The examples described above illustrate a schema generation method/system that provide an optimal subset of source and target schemas by analyzing previous mappings to identify the ‘most-used’ mappings. By reducing the size of the schema for the mapping system, embodiments may reduce a time required to initially generate the schema by only needing to generate the most common parts.

It should now be understood by those of skill in the art, in embodiments of the present invention, the proposed concepts provide numerous advantages over conventional schema generation approaches. These advantages include, but are not limited to, reducing the size of a schema.

In still further advantages to a technical problem, the systems and processes described herein provide a computer-implemented method for efficient schema generation. In this case, a computer infrastructure, such as the computer system shown in FIGS. 1 and 2 can be provided and one or more systems for performing the processes of the invention can be obtained (e.g., created, purchased, used, modified, etc.) and deployed to the computer infrastructure. To this extent, the deployment of a system can comprise one or more of:
(i) installing program code on a computing device, such as computer system shown in FIG. 2, from a computer-readable medium;
(ii) adding one or more computing devices to the computer infrastructure and more specifically the cloud environment; and
(iii) incorporating and/or modifying one or more existing systems of the computer infrastructure to enable the computer infrastructure to perform the processes of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating a schema describing a first node for performing mapping tasks, the method comprising:
obtaining an output schema for the first node;
extracting, from the output schema, configuration data for the first node, wherein the configuration data includes an object and an action associated with the first node;
analyzing a dataset of historical mappings to identify previous mappings that reference the object or the action associated with the first node; and
generating a modified output schema describing the first node based, at least in part, on the identified previous mappings and the output schema, wherein the modified output schema is devoid of at least one portion of output schema.

2. The computer-implemented method of claim 1, wherein modifying the output schema comprises:
determining a set of mappings that meet a predetermined usage requirement based, at least in part, on the identified previous mappings;
identifying one or more portions of the output schema that do not refer to at least one mapping of the set of mappings; and
editing or removing the identified one or more portions of the output schema.

3. The computer-implemented method of claim 2, wherein determining a set of mappings that meet a predetermined usage requirement comprises:
for each of the identified previous mappings:
determining a frequency of occurrence of the identified previous mapping in the dataset of historical mappings; and
responsive to determining frequency of occurrence of the identified previous mapping exceeds a predetermined usage value, including the identified previous mapping in the set of mappings.

4. The computer-implemented method of claim 1, wherein analyzing a dataset of historical mappings comprises:
for each mapping between the object and action associated with the first node:
comparing the mapping with the dataset of historical mappings to determine whether or not to identify the mapping as a previous mapping; and
responsive to identifying the mapping as a previous mapping, increasing a usage score value associated with the previous mapping, wherein a usage score value represents a frequency of occurrence of the associated mapping in the dataset of historical mappings.

5. The computer-implemented method of claim 1, further comprising:
generating supplementary information describing the at least one portion of output schema that devoid from modified output schema; and
associating the supplementary information with the modified output schema.

6. The computer-implemented method of claim 5, wherein associating the supplementary information with the modified output schema comprises:
including the supplementary information in the modified output schema.

7. The computer-implemented method of claim 1, wherein the first node is an input node of a flow, and wherein the method further comprises:
communicating the modified output schema to a client.

8. The computer-implemented method of claim 1, wherein the first node is a downstream node of a flow, and wherein the method further comprises:
obtaining an input schema for the first node;
extracting, from the input schema, second configuration data for the first node, wherein the second configuration data includes a second object and a second action associated with the first node;
analyzing the dataset of historical mappings to identify previous mappings that reference the second object or the second action associated with the first node; and
modifying the input schema to generate a modified input schema describing the first node based, at least in part, on the identified previous mappings, wherein the modified input schema is devoid of at least a portion of input schema.

9. The computer-implemented method of claim 8, wherein modifying the input schema comprises:
determining a second set of mappings that meet a predetermined usage requirement based, at least in part, on the identified previous mapping that reference the second object or the second action associated with the first node;
identifying one or more portions of the input schema that do not refer to at least one mapping of the second set of mappings; and
editing or removing the identified one or more portions of the input schema.

10. The computer-implemented method of claim 9, wherein determining a second set of mappings that meet a predetermined usage requirement comprises:
for each of the identified previous mappings that reference the second object or the second action associated with a one or more first nodes:
determining a frequency of occurrence of the identified previous mapping in the dataset of historical mappings; and
responsive to determining frequency of occurrence of the identified previous mapping exceeds a predetermined usage value, including the identified previous mapping in the second set of mappings.

11. The computer-implemented method of claim 8, further comprising:
generating second supplementary information describing the at least one portion of input schema that devoid from modified input schema; and
associating the second supplementary information with the modified input schema.

12. The computer-implemented method of claim 11, wherein associating the second supplementary information with the modified input schema comprises:
including the second supplementary information in the modified input schema.

13. A computer program product for generating a schema describing a first node for performing mapping tasks, the computer program product comprising a computer readable storage medium having program instructions embodied therewith, the program instructions executable by a processing unit to cause the processing unit to perform a method comprising:
obtaining an output schema for the first node;
extracting, from the output schema, configuration data for the first node, wherein the configuration data includes an object and an action associated with the first node;
analyzing a dataset of historical mappings to identify previous mappings that reference the object or the action associated with the first node; and
generating a modified output schema describing the first node based, at least in part, on the identified previous mappings and the output schema, wherein the modified output schema is devoid of at least one portion of output schema.

14. The computer program product of claim 13, wherein modifying the output schema comprises:
determining a set of mappings that meet a predetermined usage requirement based on the identified previous mappings;
identifying one or more portions of the output schema that do not refer to at least one mapping of the set of mappings; and
editing or removing the identified one or more portions of the output schema.

15. The computer program product of claim 14, wherein determining a set of mappings that meet a predetermined usage requirement comprises:
for each of the identified previous mappings:
determining a frequency of occurrence of the identified previous mapping in the dataset of historical mappings; and
responsive to determining frequency of occurrence of the identified previous mapping exceeds a predetermined usage value, including the identified previous mapping in the set of mappings.

16. The computer program product of claim 13, wherein analyzing a dataset of historical mappings comprises:
for each mapping between the object and action associated with the first node:
comparing the mapping with the dataset of historical mappings to determine whether or not to identify the mapping as a previous mapping; and
responsive to identifying the mapping as a previous mapping, increasing a usage score value associated with the previous mapping, wherein a usage score value represents a frequency of occurrence of the associated mapping in the dataset of historical mappings.

17. The computer program product of claim 13, further comprising:
generating supplementary information describing the at least one portion of output schema that devoid from modified output schema; and
associating the supplementary information with the modified output schema.

18. The computer program product of claim 17, wherein associating the supplementary information with the modified output schema comprises:
including the supplementary information in the modified output schema.

19. The computer program product of claim 13, wherein the first node is an input node of a flow, and wherein the method further comprises:
communicating the modified output schema to a client.

20. The computer program product of claim 13, wherein the first node is a downstream node of a flow, and wherein the method further comprises:
obtaining an input schema for the first node;
extracting, from the input schema, second configuration data for the first node, wherein the second configuration data includes a second object and a second action associated with the first node;
analyzing the dataset of historical mappings to identify previous mappings that reference the second object or the second action associated with the first node; and
modifying the input schema to generate a modified input schema describing the first node based, at least in part, on the identified previous mappings, wherein the modified input schema is devoid of at least a portion of input schema.

21. The computer program product of claim 20, wherein modifying the input schema comprises:
determining a second set of mappings that meet a predetermined usage requirement based, at least in part, on the identified previous mapping that reference the second object or the second action associated with the first node;
identifying one or more portions of the input schema that do not refer to at least one mapping of the second set of mappings; and
editing or removing the identified one or more portions of the input schema.

22. The computer program product of claim 21, wherein determining a second set of mappings that meet a predetermined usage requirement comprises:
for each of the identified previous mappings that reference the second object or the second action associated with a one or more first nodes:
determining a frequency of occurrence of the identified previous mapping in the dataset of historical mappings; and
responsive to determining frequency of occurrence of the identified previous mapping exceeds a predetermined usage value, including the identified previous mapping in the second set of mappings.

23. The computer program product of claim 20, further comprising:
generating second supplementary information describing the at least one portion of input schema that devoid from modified input schema; and
associating the second supplementary information with the modified input schema.

24. A computer system for generating a schema describing a first node for performing mapping tasks, comprising:
one or more computer processors;
one or more computer readable storage media; and
computer program instructions, the computer program instructions being stored on the one or more computer readable storage media for execution by the one or more computer processors, the computer program instructions including instructions to:
obtain an output schema for the first node;
extract, from the output schema, configuration data for the first node, wherein the configuration data includes an object and an action associated with the first node;
analyze a dataset of historical mappings to identify previous mappings that reference the object or the action associated with the first node; and
generate a modified output schema describing the first node based, at least in part, on the identified previous mappings and the output schema, wherein the modified output schema is devoid of at least one portion of output schema.

25. The computer system of claim 24, wherein the instructions to modify the output schema comprises instructions to:
determine a set of mappings that meet a predetermined usage requirement based on the identified previous mappings;
identify one or more portions of the output schema that do not refer to at least one mapping of the set of mappings; and
edit or remove the identified one or more portions of the output schema.
